(19) United States
(12) Patent Application Publication
(10) Pub. No.: US 2008/0065837 A1
(43) Pub. Date: Mar. 13, 2008

(54) Computerized numerical control system with human interface using low cost shared memory

(75) Inventors: Tatsuo Toyonaga, San Jose, CA (US); Curtis Hoi Sze Wong, San Jose, CA (US)

Correspondence Address: MCDERMOTT WILL & EMERY LLP, 18191 VON KARMAN AVE., SUITE 500, IRVINE, CA, 92612-7108, US

(73) Assignees: Sodick Co., Ltd.; Sodick America Corporation

(21) Appl. No.: 11/516,610

(22) Filed: Sep. 7, 2006

(51) Int. Cl. G06F 12/00

(52) U.S. Cl. 711/148

(57) ABSTRACT

A computerized numerical control system includes a human interface computer (1), a PCI bus (4) which is adapted to couple to the human interface computer, and a numerical control device (3). The numerical control device includes an embedded processor (30) and a local bus (34) coupled to the embedded processor. A first and second low cost shared memories such as SDRAMs (10, 11) and a dual bus memory controller (2) are provided. The first and second shared memories are shared by the human interface computer and the embedded processor. The dual bus memory controller is configured for concurrent communication with the PCI bus and the local bus and is adapted to couple to the first and second shared memories.

### BACKGROUND OF THE INVENTION

1. Field of the Invention

The present invention relates to a computerized numerical control (“CNC”) system for controlling the position of tool or work in a machine tool according to instruction data. More particularly, the present invention relates to a CNC system having a human interface computer by which a machine tool operator can enter instruction data and monitor feedback data.

2. Description of the Related Art

In general, a computerized numerical control system for a machine tool is equipped with a human interface computer 1, as shown in FIG. 1. The human interface computer 1 includes a processor, an input device and a display device and provides a graphical user interface for controlling a machine tool. The input device may be a keyboard and any type of pointing device including a joystick, a mouse, a trackball or a touch pad. The display monitor may be a liquid-crystal display device. A PCI (Peripheral Components Interconnect) bus 4 is adapted to couple to the human interface computer 1. The human computer 1 can send instruction data to a shared memory module 35 in a numerical control device 3 through the PCI bus 4. The instruction data is data to be executed by an embedded processor 30 in the numerical control device 3 and may be included in an NC program. The NC program is comprised of coded instructions which are described by one line defining movement of a tool or workpiece, circular interpolation, machining conditions and etc. Feedback data representative of position, velocity or current is supplied to the embedded processor 30 from the machine tool through motor drives 6. The embedded processor 30 writes the feedback data to the shared memory 35 and updates it. The human interface computer 1 reads the feedback data from the shared memory 35 and displays it on the display monitor. An expansion bus such as the PCI bus 4 provides a communication bridge between a human interface computer 1 and the numerical control device 3. The numerical control device 3 includes the embedded processor 30, a PCI bus interface 32, a memory controller 36, the shared memory 35 and an external bus interface 38 for IO access. The embedded processor 30 analyzes and executes the instruction data in the shared memory 35. The PCI bus interface 32 is operable to interface the PCI bus 4 to the shared memory 35. The memory controller 36 is adapted to couple to the shared memory 34. The shared memory 35 includes a SDR SDRAM (Single Data Rate Synchronous Dynamic Random Access Memory) or DDR SDRAM (Double Data Rate Synchronous Dynamic Random Access Memory) each of which is capable of reading and writing at high speed. The shared memory 35 is used as a memory local to the embedded processor 30 and provides a memory space for the instruction data and feedback data. Such memory space, known as a shared memory, is also accessed by the human interface computer 1 via the PCI bus interface 32. Though the shared memory 35 is included in the numerical control device 3 in the drawings, it may be provided outside of the numerical control device 3. When the embedded processor 30 reads an instruction on motor's motion, it generates a position command of each control axis. Known position control loop and velocity control loop are included in the numerical control device 3. The embedded processor 30 supplies a current command to motor drivers 6 to control the driving of X-axis, Y-axis and Z-axis motors. The motors drivers 6 include current control loops and power amplifiers and supply the controlled current to motors, respectively. Feedback data for position and velocity of each motor is transferred to the embedded processor 30 and stored in the shared memory 35. Feedback data for current being supplied to motors is also transferred to the motor drivers 6 and stored in the shared memory 35. Most of the numerical control device 3 has a local bus 34 which is coupled to the embedded processor 30 and all controller modules such as the PCI bus interface 32, the memory controller 36 and the external bus interface 38. The local bus 34 allows the embedded processor 30 to communicate to all controller modules. Thus, two main buses, the PCI bus 4 and local bus 34 are used in the computerized numerical control system.

There is a serious problem in this conventional technology. When the human interface computer 1 is accessing the shared memory 35, it is granted access to both the PCI bus 4 and the local bus 34. Meanwhile, communication between the embedded processor 30 and the motor drivers 6 is stalled until the processor 30 can be regranted the usage of the local bus 34. This results in lost of real time communication between the processor 30 and motor drivers 6. It is likely to lead to error during controlling motor's motion, as shown in FIG. 2. Or, phase cycle time need to be increased which reduces the performance of motor's motion control. On the other hand, when the local bus 34 access is granted by the embedded processor 30 for controlling motor's motion, data update process in a human interface computer 1 will be stalled. Although this will not lead to a serious error in motor's motion control, data update process will slow down. The conventional architecture is not good enough to provide high performance in a computerized numeric control system.

As shown in FIG. 3, another alternative conventional technology uses a DPRAM (Dual Port Random Access Memory or Dual Port RAM) 9 as a shared memory. An SDRAM 37, which is provided in the numerical control device 3, is only local to the embedded processor 30. Use of the DPRAM 9 can provide separated port between the embedded processor 30 and the human interface computer 1. In the other words, both the embedded processor 30 and the human interface computer 1 can access to the DPRAM 9 concurrently. Although this conventional design has solved the above described problem, the cost of production is drastically increased because the Dual Port RAM is very expensive compared to a SDRAM. In addition, Dual Port RAM is only suitable for small data block transfer. During a large data block transfer such as NC code loading, the performance of data transferring is decreased.

### SUMMARY OF THE INVENTION

An object of the present invention is to provide a computerized numerical control system in which communications between a numerical control device and motor drivers will not be halted while a human interface computer reads feedback data from or writes instruction data to the shared memory.

Another object of the present invention is to provide a computerized numerical control system which eliminates the use of expensive Dual Port RAM.

Yet another object of the present invention is to provide a computerized numerical control system which allows fast and massive data transfer at low cost.

According to the present invention, a computerized numerical control system for controlling a machine tool according to instruction data, includes a human interface computer, an expansion bus which is adapted to couple to the human interface computer, a numerical control device including an embedded processor and a local bus coupled to the embedded processor, a first shared memory shared by the human interface computer and the embedded processor, a second shared memory shared by the human interface computer and the embedded processor, and a dual bus memory controller which is configured for concurrent communication with the expansion bus and the local bus and is adapted to couple to the first and second shared memories. For example, the expansion bus may be an PCI bus.

Preferably, the dual bus memory controller prohibits a write access to the first shared memory from the embedded processor and a write access to the second shared memory from the human interface computer.

Alternatively, the human interface computer may limit a write access to the second shared memory and the embedded processor may limit a write access to the first shared memory.

It is preferable that the dual bus memory controller includes an expansion bus interface and an external bus interface. The expansion bus interface is operable to interface the expansion bus to the first and second shared memories while the external bus interface is operable to interface the local bus to the first and second shared memories. For example, the expansion bus interface may be an PCI bus interface.

It is also preferable that the dual bus memory controller includes a first memory controller and a second memory controller. The first memory controller is adapted to couple to the first shared memory while the second memory controller is adapted to couple to the second shared memory.

Preferably, the dual bus memory controller includes four FIFO buffers which buffer data from the expansion buses and local bus to the first and second memory controllers.

It is preferable that the human interface computer can write the instruction data only to the first shared memory and that the embedded processor can write a feedback data, which is supplied from the machine tool, only to the second shared memory. The embedded processor reads and executes the instruction data while the embedded processor reads and displays the feedback data. The feedback data is, for example, position feedback, velocity feedback and current feedback.

It is preferable that the dual bus memory controller is implemented in hardware description language using FPGA and that each of the first and second shared memories is a low cost SDR SDRAM or DDR SDRAM.

### BRIEF DESCRIPTION OF THE DRAWINGS

FIG. 1 is a block diagram showing a CNC system of prior art.

FIG. 2 is a block diagram showing access to a shared memory by a human interface computer in the CNC system of FIG. 1.

FIG. 3 is a block diagram showing another CNC system of prior art using a Dual Port RAM.

FIG. 4 is a block diagram showing a CNC system of the present invention.

FIG. 5 is a block diagram showing read access through the PCI bus and motor control communication through the local bus in the CNC system of FIG. 4.

FIG. 6 is a block diagram showing one example of a dual bus memory controller in FIG. 4.

FIG. 7 is a block diagram showing write access through PCI and local buses in the dual bus memory controller of FIG. 6.

FIG. 8 is a block diagram showing read access through PCI and local buses in the dual bus memory controller of FIG. 6.

FIG. 9 is timing diagrams showing read and write transaction from PCI and local buses in the dual bus memory controller of FIG. 6.

FIG. 10 is a block diagram showing one example of FIFO buffer in FIG. 6.

FIG. 11 is a block diagram showing one example of a memory controller in FIG. 6.

FIG. 12 is a block diagram showing concurrent transactions through PCI and local buses in the dual bus memory controller of FIG. 6.

FIG. 13 is timing diagrams showing concurrent read and write transaction from PCI and local buses in the dual bus memory controller of FIG. 6.

### DETAILED DESCRIPTION OF THE INVENTION

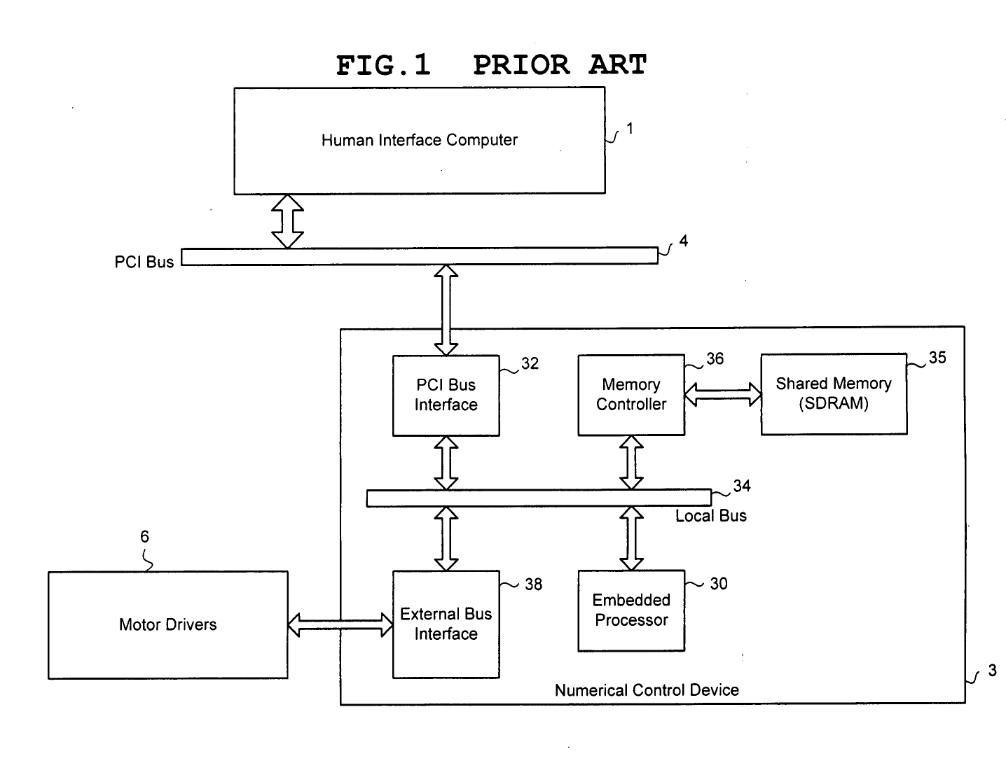

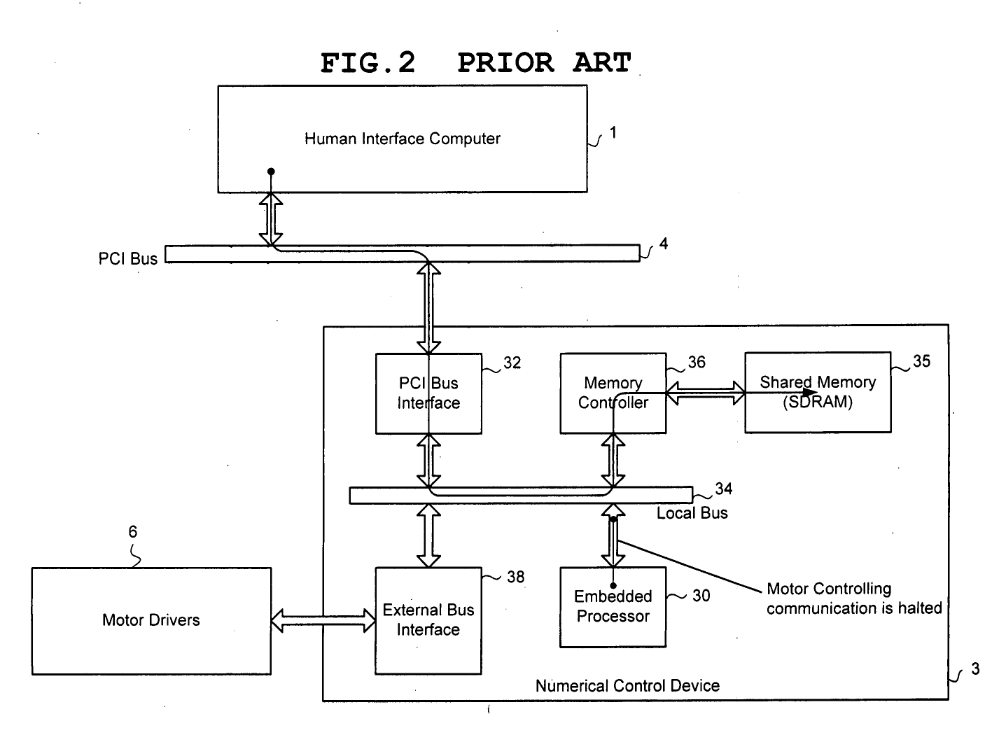

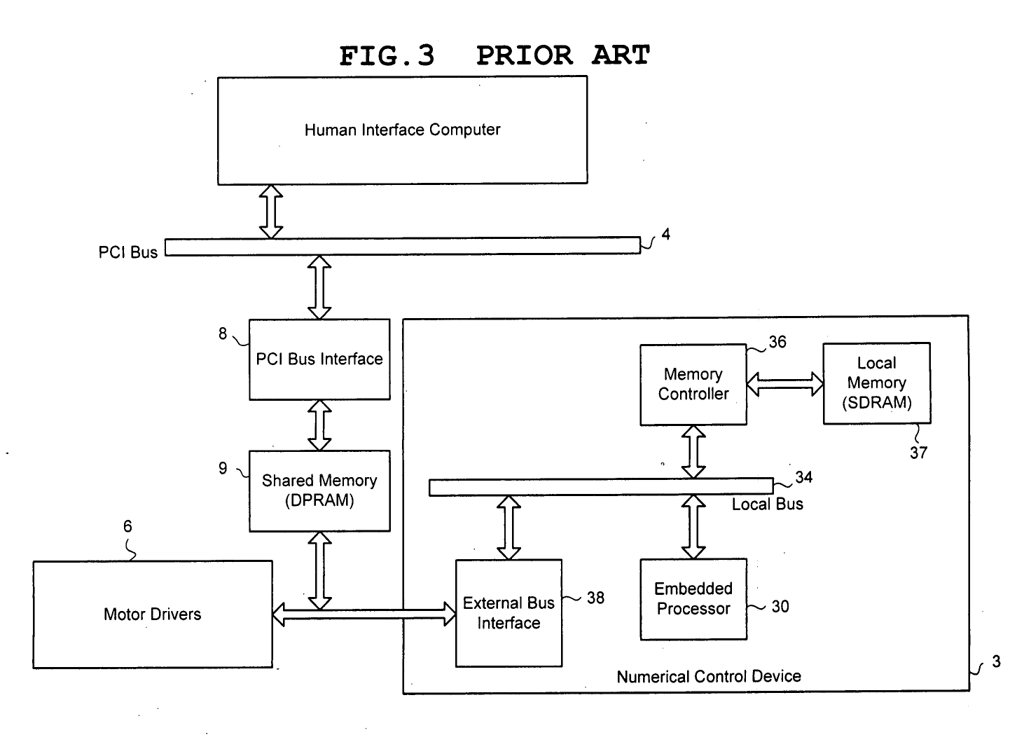

An exemplary embodiment of a CNC system of the present invention will now be described with reference to the drawings. Similar elements are labeled with similar reference numerals as used in FIGS. 1-3, their detailed explanation will be omitted.

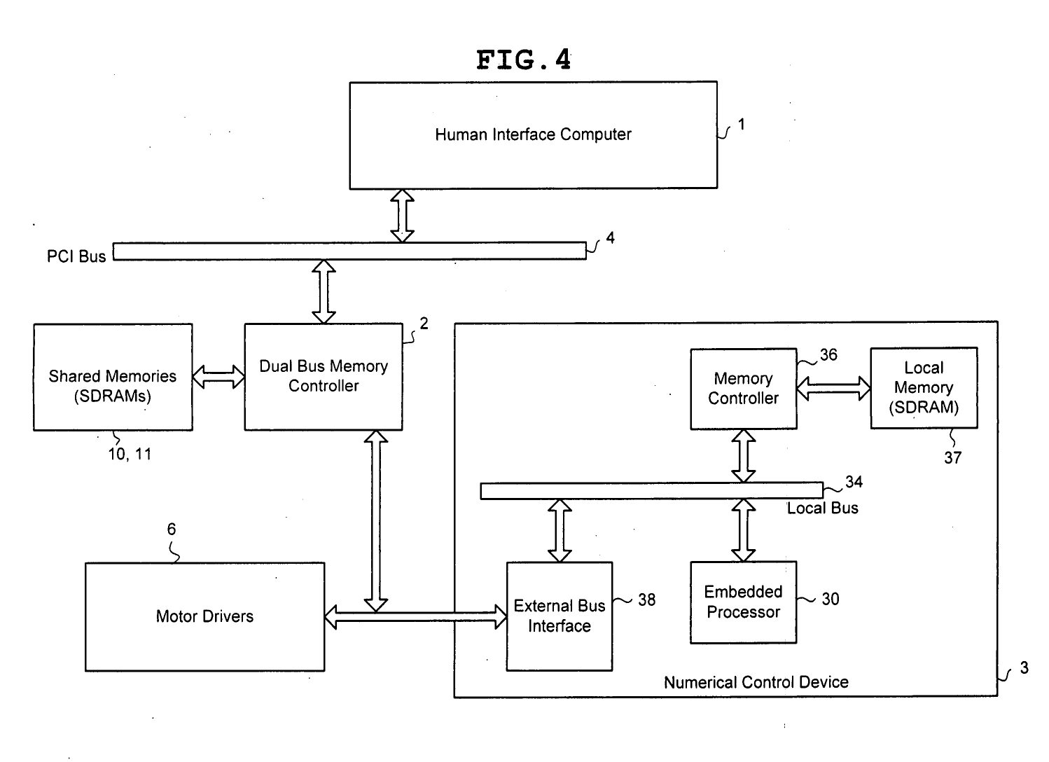

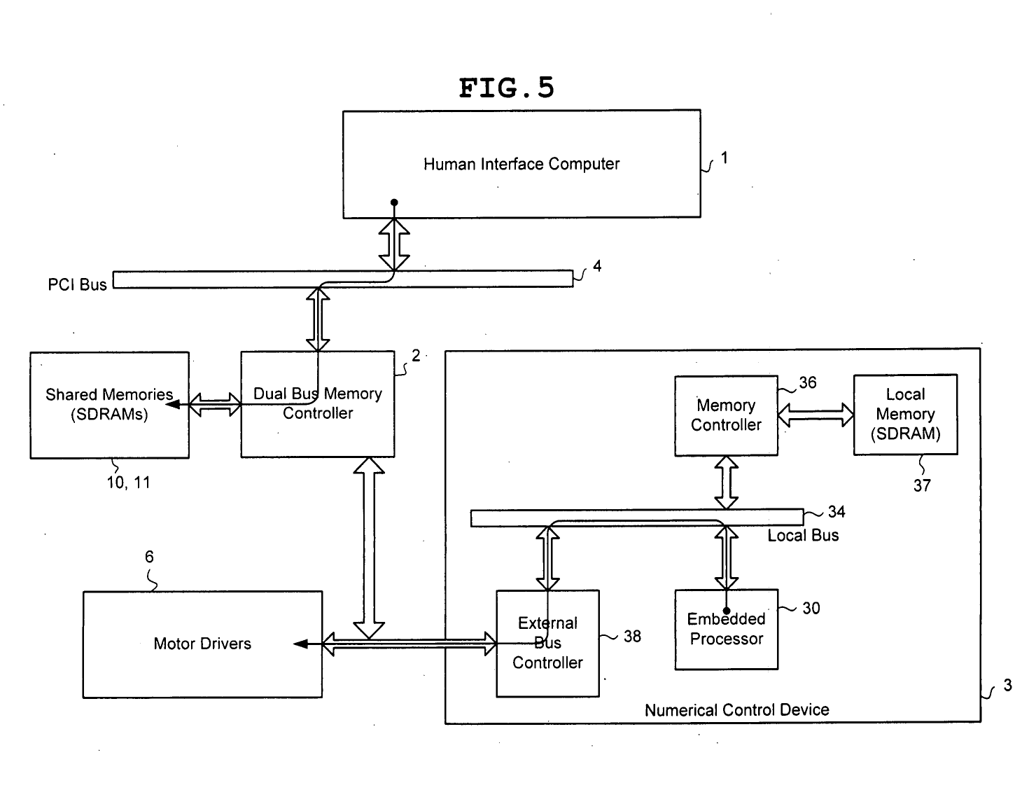

In this invention, a shared memory is not controlled by the embedded processor 30 anymore. It is controlled by a hardware module 2 that is implemented in hardware description language using FPGA (Field Programmable Gate Array) technology. As shown in FIG. 4, this hardware module 2 is named dual bus memory controller and is coupled between the PCI bus 4 and the local bus 34. Both of the human interface computer 1 and the embedded processor 30 are not granted access to buses 4 and 34. The dual bus memory controller 2 is configured for concurrent communication with the PCI bus 4 and the local bus 34 and is adapted to couple to shared memory modules 10 and 11 both of which are shared by the human interface computer 1 and the embedded processor 30. As a result of this design, the local bus 34 is free for the embedded processor 30 to communicate with motor drivers 6 without wait time while the human interface computer 1 carries out a write/read access to the shared memory 10 or 11 through the PCI bus 4, as shown in FIG. 5. As a result, a higher performance of controlling the motor's motion controlling is provided.

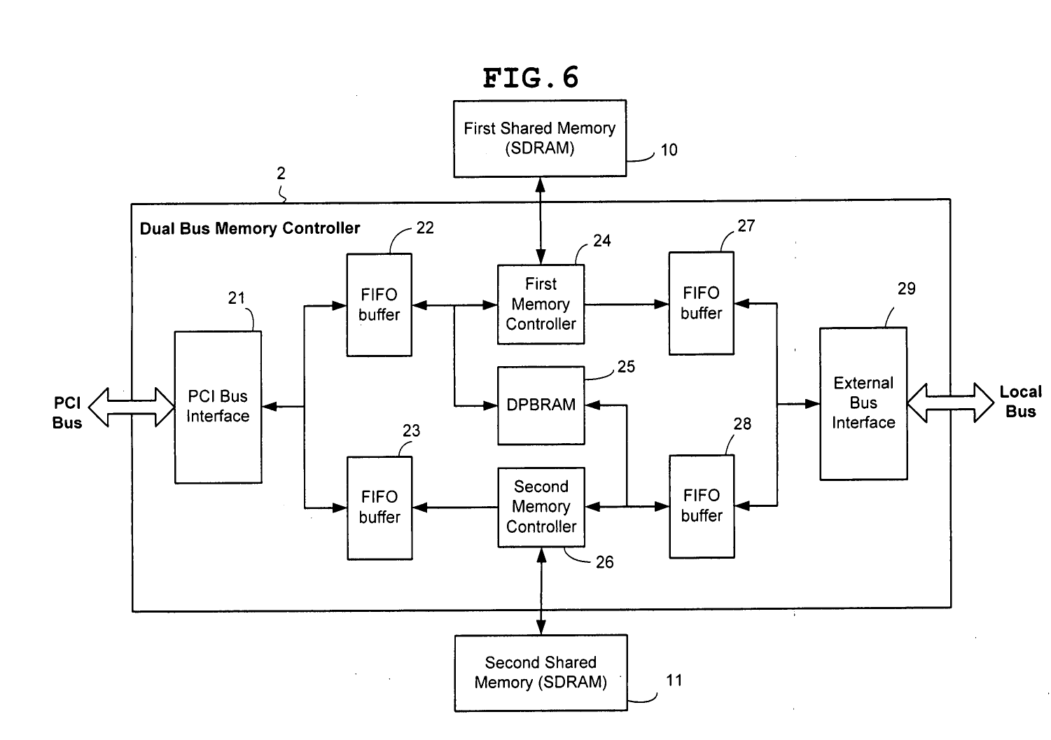

As shown in FIG. 6, the dual bus memory controller 2 includes an expansion bus interface 21, an external bus interface 29 and memory controllers 24 and 26. The first memory controller 24 is coupled to the first shared memory 10 and the second memory controller 26 is coupled to the second shared memory 11. The expansion bus interface 21 is operable to interface the PCI bus 4 to the shared memories 10 and 11 while an external bus interface 29 is operable to interface with the local bus 34 to the shared memories 10 and 11. The PCI bus interface 21 allows the human interface computer 1 to issue read/write access to the first memory controller 24. But, it allows the human interface computer 1 to issue only a read access to the second memory controller 26. On the other hand, the external bus interface 29 allows the embedded processor 30 to read data from or write data to the second memory controller, but it allows the embedded processor 30 only to read data from the first memory controller 24. Thus, the dual bus memory controller 2 prohibits a write access to the second memory 11 from the human interface computer 1 and a write access to the second memory 11 from the human interface computer 1 and a write access to the first shared memory 10 from the embedded processor 30. Alternatively, the human interface computer 1 may limit a write access to the second shared memory 11 and the embedded processor 30 may limit a write access to the first shared memory 10. Though most of FPGA products in a computerized numerical control system provides use of a Dual Port RAM, each of the shared memories 10 and 11 is a low cost SDR SDRAM or DDR SDRAM, and they are meant for massive data transfer. Each of the shared memories 10 and 11 may be SRAM. Beside the shared memories 10 and 11, a DPBRAM (Dual Port Block Random Access Memory) module 25 in FPGA is used to provide a small shared data area for fast read/write access from both the human interface computer 1 and embedded processor 30. This memory area is meant to store control words at faster transaction and lower latency rates than the shared memories 10 and 11. In addition, four FIFO buffer (first-in-first-out buffer) modules 22, 23, 27 and 28 are used to buffer the data from the buses 4 and 34 to the memory controllers 24 and 26. They are exactly same module with write/read control signals for read-only control. The FIFO buffer 22 is coupled between the PCI bus interface 21 and the first memory controller 24 and the FIFO buffer 23 is coupled between the PCI bus interface 21 and the second memory controller 26. The FIFO buffer 27 is coupled between the external bus interface 29 and the first memory controller 24 and the FIFO buffer 28 is coupled between the external bus interface 29 and the second memory controller 26.

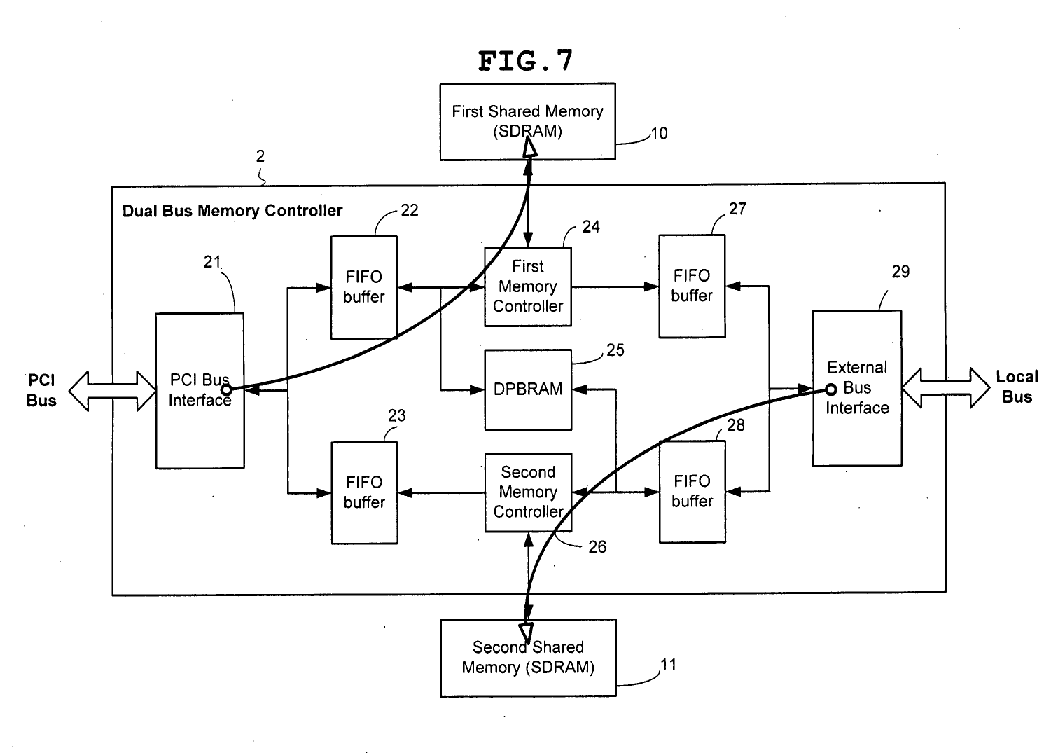

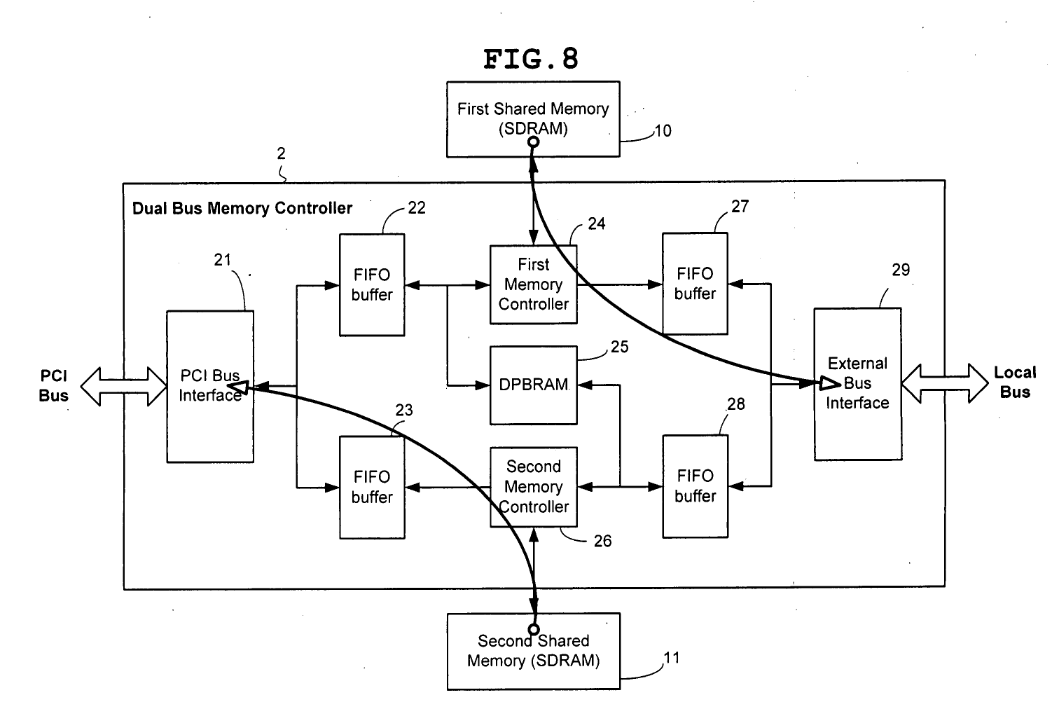

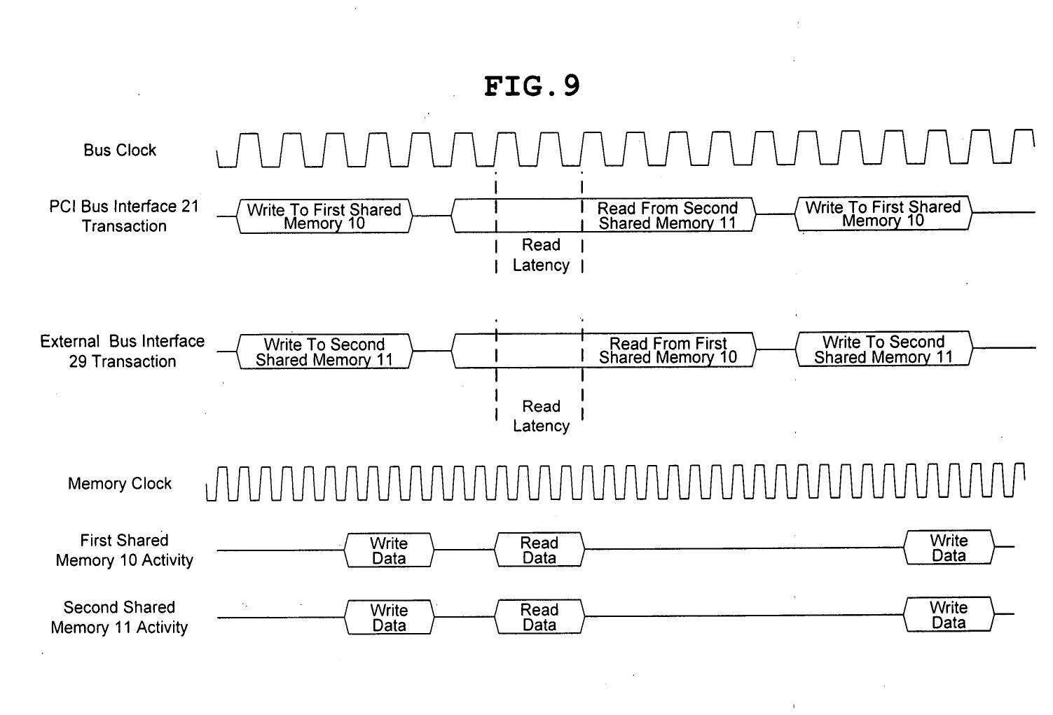

As shown in FIG. 7, while the human interface computer 1 writes instruction data such as an NC program to the first shared memory 10 through the first memory controller 24, the embedded processor 30 also can access to the second shared memory 11 through the second memory controller 26 to updated feedback data. Data is written in to the shared memories 10 and 11 through the PCI bus 4 and the local bus 34 concurrently. As shown in FIG. 8, the embedded processor 30 reads the NC program from the first shared memory 10 through the first memory controller 24 while feedback data is read from the second shared memory 11 through the second memory controller 26 by the human interface computer 1 and displayed on the graphical user interface. FIG. 9 illustrates the PCI bus transaction and the local bus transaction occurring concurrently, and the first and second memory controllers 24 and 26 issue read and write transfer with the first and second shared memories 10 and 11. Because of the dual memory module architecture, concurrent read or write on different shared memories is possible.

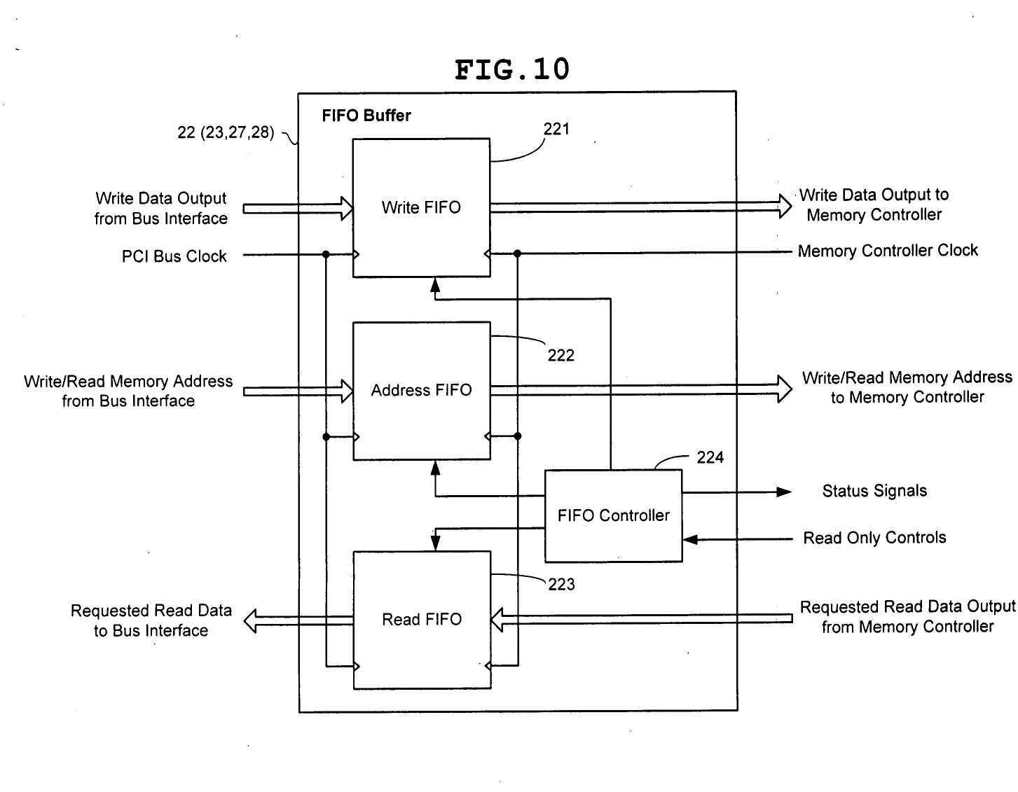

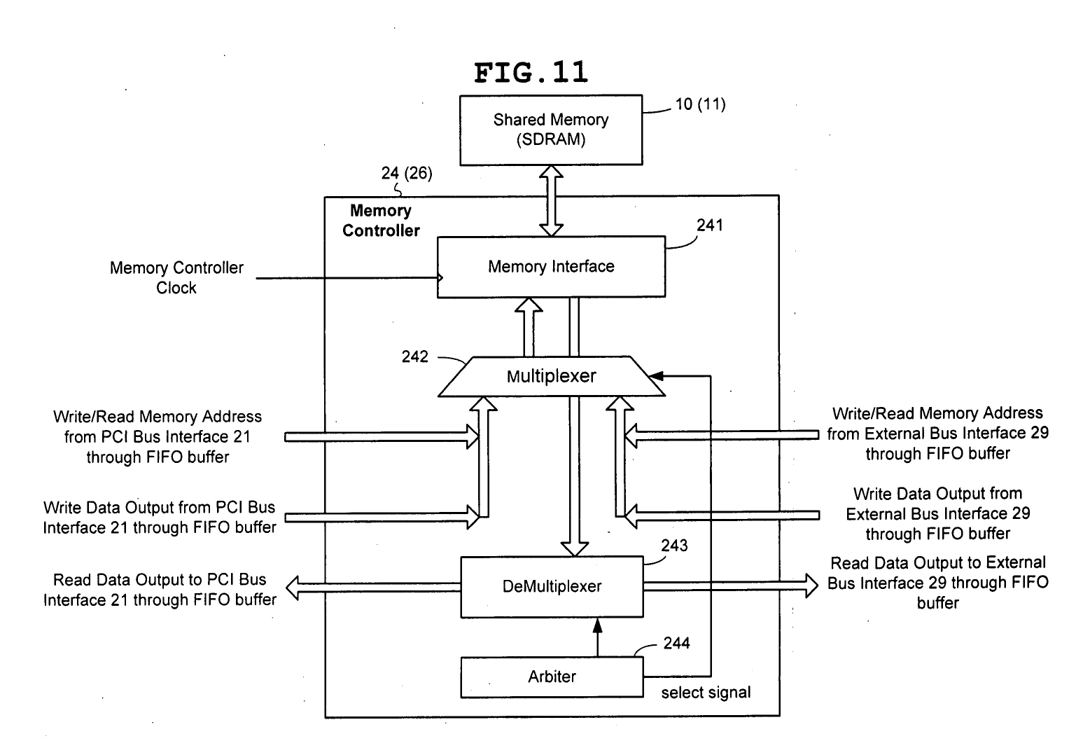

In the case of accessing the same shared memory by two bus interfaces 21 and 29 at the same time, FIFO buffers will work as temporary storage for data and the memory controllers 24 and 26 arbitrate priority of accesses from the buses 4 and 34. Three different clocks are used in the embodiment, a memory clock, a local bus clock, and an expansion bus clock which is a PCI bus clock. The FIFO buffers 22, 23, 27 and 28 are the main modules to synchronize and buffer data. As shown in FIG. 10, each FIFO buffer 22, 23, 27 and 28 includes three asynchronous FIFOs 221, 222 and 223 and a FIFO controller 224. The asynchronous FIFOs 221, 222 and 223 allow data synchronization from the buses 4 and 34 to the memory controllers 24 and 26. The write FIFO 221 is a first-in-first-out buffer that stores and synchronizes data from the bus interface 21 or 29 to the memory controller 24 or 26. The address FIFO 222 is exactly same as the write FIFO 221. The only difference is that the address FIFO 222 stores and synchronizes address location of the data in write transaction. When data is written into the shared memory 10 or 11, the data and its memory location (address) are stored in the write FIFO 221 and the address FIFO 222, respectively. The FIFO controller 224 is a state machine that controls the all FIFOs 221, 222 and 223 in a FIFO buffer 22. It also generates the FIFO status signals such as write FIFO not-empty signal. These status signals inform the memory controller 24 or 26 to start a memory write transaction and data is written into the shared memory 10 or 11. During a read transaction, request address is loaded into the address FIFO 222. The memory controller 24 or 26 serves a request and read data into the read FIFO 223. Then, requested read data is synchronized and sent to the bus interface 21 or 29. If the memory controller 24 or 26 is operating other transactions for the other bus, data and its address locations are stored in the write FIFO 221 and address FIFO 222 until the memory controller 24 or 26 serves the transaction in the FIFO buffer. The priority of transactions is determined by an arbiter module 244 in each memory controller 24 and 26 in FIG. 11.

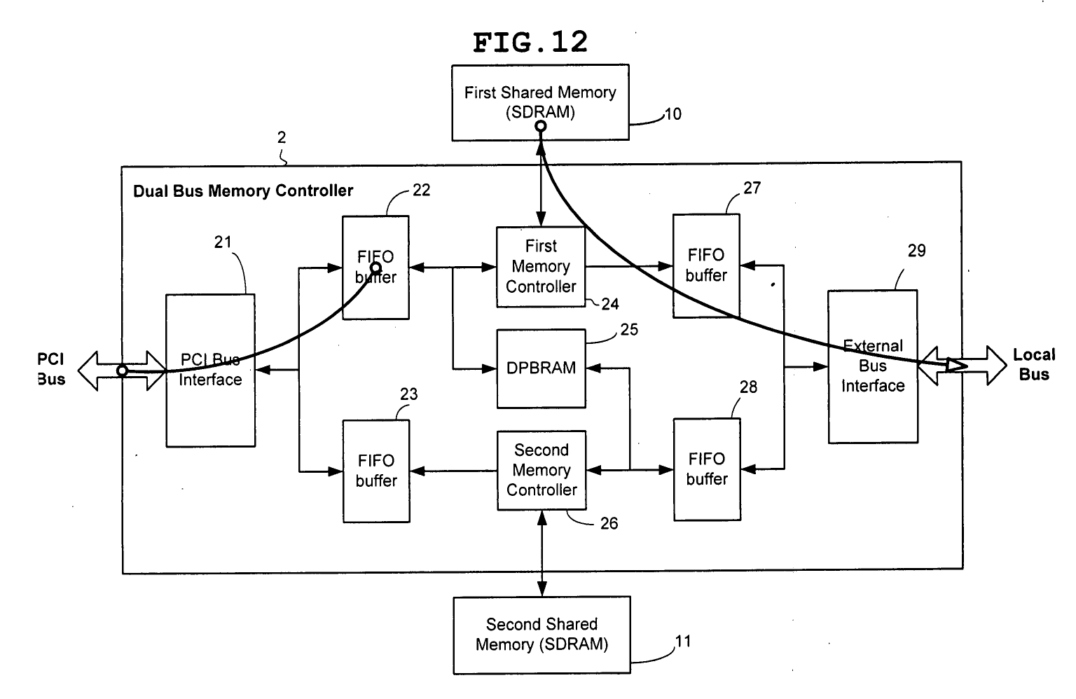

The first and second memory controllers 24 and 26 have the same architecture shown in FIG. 11. Each memory controller 24 and 26 is a dual port memory controller that allows two address data buses to be connected to it. It contains a memory interface module 241 which interfaces data and address bus with the shared memory 10 or 11. In addition, different type of memory module can be used in one computerized numerical control system by implementing different type of the memory interface 241. The arbiter 244 determines the priority of bus requests. It sends a select signal to a multiplexer module 242 to switch a different bus request to the memory interface 241. During read transactions, the memory interface 241 serves the read request from address bus and send read data to a demultiplexer module 243. Then, the arbiter module 244 selects the data path to the bus interface 2 or 29. When the PCI bus 4 requests a write transaction and the local bus 34 requests a read transaction at the same time, the FIFO buffer 22 stores the write data from the PCI bus 4. And, the first memory controller 24 reads data from the first shared memory 10 to the FIFO buffer 27. The PCI bus interface 21 will not stop the write transaction from the PCI bus 4 unless the FIFO buffer 22 is full. After the first memory controller 24 fills the read FIFO 223 in the FIFO buffer 27, it will store the write data into the first shared memory 10. As a result, both local bus transaction and PCI bus transaction can be active at the same time with no influence to the others, a shown in FIG. 12. If the FIFO buffer 22 is full, the PCI bus 4 will need to issue a stop signal. To minimize the number of stop or retry in a transaction, the size of the write FIFO 221 in FIG. 10 should be as large as possible. On the other hand, the size of the read FIFO 223 in FIG. 10 should not be larger than the maximum size of a memory burst read. Also, memory transfer speed should be two times of the bus transfer speed.

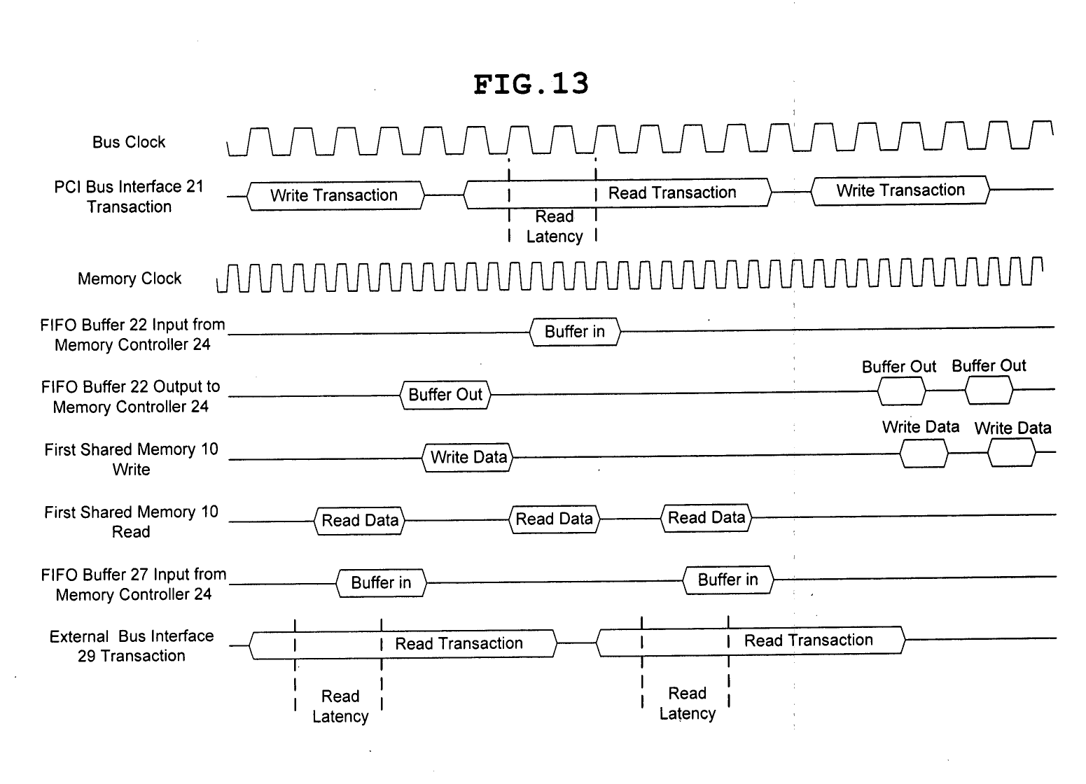

FIG. 13 shows an example of concurrent transactions from the PCI bus 4 and local bus 34. In the example, memory clocks are running at two times faster than bus clocks and the local bus 34 has the same speed of the PCI bus 4. Also, each shared memory 10 and 11 has a 4 words burst read access. Because the local bus 34 is designed to have higher priority, the memory controller 24 firstly reads data from the shared memory 10 and stores the data into the FIFO buffer 27. The memory controller 24 secondly reads data that is stored in the FIFO buffer 22, and it sends the data to the shared memory 10. At this point, the first read transaction of the local bus 34 and write transaction of the PCI bus 4 are served. The memory controller 24 accepts the read request from the PCI bus 4 and reads data from the shared memory 10 immediately because the local bus 34 is still reading data from the FIFO buffer 27. The memory controller 24 sends request data to the FIFO buffer 22 while the external bus interface 29 requests another read transaction from the shared memory 10. The second request from the external bus interface 29 starts after the memory controller 24 sends read data to the FIFO buffer 22. At last, the memory controller 24 serves write transaction from the PCI bus interface 21. If a read transaction from the local bus 34 happens during the last write transaction, the memory controller 24 will stop the write transaction. The write transaction is restarted after the read transaction is completed. In the case of read/write control words for motor control, the dual port block RAM 25 located in FPGA is taking part in the transaction.

The present invention is not intended to be limited to the disclosed form. It is clear that many improvements and variations are possible with reference to the above description. The illustrated embodiment was selected to explain the essence and practical application of the invention. The scope of the invention is defined by the attached claims.

What is claimed is:

1. A computerized numerical control system for controlling a machine tool according to instruction data comprising:
a human interface computer;
an expansion bus which is coupled to the human interface computer;
a numerical control device including an embedded processor and a local bus coupled to the embedded processor;
a first shared memory shared by the human interface computer and the embedded processor;
a second shared memory shared by the human interface computer and the embedded processor; and
a dual bus memory controller which controls concurrent communication with the expansion bus and the local bus and is coupled to the first and second shared memories.

2. The computerized numerical control system of claim 1, wherein the dual bus memory controller prohibits a write access to the first shared memory from the embedded processor and a write access to the second shared memory from the human interface computer.

3. The computerized numerical control system of claim 1, wherein the human interface computer limits a write access to the second shared memory and the embedded processor limits a write access to the first shared memory.

4. The computerized numerical control system of claim 1, wherein the dual bus memory controller includes an expansion bus interface and an external bus interface wherein the expansion bus interface is operable to interface the expansion bus to the first and second shared memories while the external bus interface is operable to interface the local bus to the first and second shared memories.

5. The computerized numerical control system of claim 1, wherein the dual bus memory controller includes a first memory controller and a second memory controller wherein the first memory controller is adapted to couple to the first shared memory while the second memory controller is adapted to couple to the second shared memory.

6. The computerized numerical control system of claim 5, wherein the dual bus memory controller includes four FIFO buffers which buffer data from the expansion buses and local bus to the first and second memory controllers.

7. The computerized numerical control system of claim 6, wherein each of the first and second memory controllers includes an arbiter which arbitrates priority of accesses from the expansion bus and local bus.

8. The computerized numerical control system of claim 1,
wherein the human interface computer can write the instruction data only to the first shared memory and the embedded processor can read the instruction data from the first shared memory for execution; and
wherein the embedded processor can write a feedback data, which is supplied from the machine tool, only to the second shared memory and the human interface computer can read the feedback data from the second shared memory for display.

9. The computerized numerical control system of claim 1, wherein the dual bus memory controller is implemented in hardware description language using FPGA.

10. The computerized numerical control system of claim 9, wherein each of the first and second shared memories is an SDRAM.

11. A computerized numerical control system for controlling a machine tool according to instruction data comprising:
a human interface computer;
a numerical control device including an embedded processor;
a first shared memory shared by the human interface computer and the embedded processor;
a second shared memory shared by the human interface computer and the embedded processor; and
a dual bus memory controller which is coupled to the first and second shared memories;
wherein the dual bus memory controller prohibits a write access to the first shared memory from the embedded processor and a write access to the second shared memory from the human interface computer.

12. A computerized numerical control system for controlling a machine tool according to instruction data comprising:
a human interface computer;
a numerical control device including an embedded processor;
a first shared memory shared by the human interface computer and the embedded processor;
a second shared memory shared by the human interface computer and the embedded processor; and
a dual bus memory controller which is coupled to the first and second shared memories;
wherein the human interface computer limits a write access to the second shared memory and the embedded processor limits a write access to the first shared memory.

13. A computerized numerical control system for controlling a machine tool according to instruction data comprising:
a human interface computer by which instruction data is entered;
a numerical control device including an embedded processor to which a feedback data is supplied from the machine tool;
a first shared memory shared by the human interface computer and the embedded processor;
a second shared memory shared by the human interface computer and the embedded processor; and
a dual bus memory controller which is coupled to the first and second shared memories;
wherein the human interface computer writes the instruction data only to the first shared memory and the embedded processor reads the instruction data from the first shared memory for execution; and
wherein the embedded processor writes the feedback data only to the second shared memory and the embedded processor reads the feedback data from the second shared memory for display.
